(19) United States
(12) Patent Application Publication
(10) Pub. No.: US 2026/0367803 A1
(43) Pub. Date: Nov. 19, 2026

(54) DETERMINISTIC POWER LOSS PROTECTION RECOVERY STATE

(71) Applicant: Sandisk Technologies, Inc., Milpitas, CA (US)

(72) Inventors: JARED ARCHIBAL, Phoenix, AZ (US); MARK DANCHO, Chandler, AZ (US); HAINING LIU, Irvine, CA (US); STEPHEN GOLD, Fort Collins, CO (US)

(73) Assignee: Sandisk Technologies, Inc., Milpitas, CA (US)

(21) Appl. No.: 19/207,429

(22) Filed: May 14, 2025

(51) Int. Cl. G06F 3/06

(52) U.S. Cl. CPC G06F 3/0619; G06F 3/0634; G06F 3/0659; G06F 3/0679

(57) ABSTRACT

A storage device may include a controller to store data to the memory device in two-stage programming operations when the device is in a first state. The controller may determine that sudden power loss occurred on the storage device, enter a second state, abort ongoing second programming operations, and store data associated with aborted ongoing second programming operations to a SLC cache. The controller may determine that the storage device is rebooted after the sudden power loss, cause the storage device to enter a third state, process the aborted second programming operations, and determine that a subsequent sudden power loss occurred while processing a first set of aborted second programming operations. The controller may complete the first set of aborted second programming operations before the storage device is rebooted, and transition to the first state when all aborted second programming operations are reprogrammed to a multi-cell storage section.

### BACKGROUND OF THE INVENTION

A storage device may be communicatively coupled to a host and to non-volatile memory including, for example, a NAND flash memory device on which the storage device may store data received from the host. The memory device may include multiple dies which may be divided into physical blocks and the storage device may store data in pages on blocks on the memory device. Data may be stored in the blocks in various formats, with the formats being defined by the number of bits that may be stored per memory cell. For example, a single-level cell (SLC) format may write one bit per memory cell, a multi-level cell (MLC) format may write two bits per memory cell, a triple-level cell (TLC) format may write three bits per memory cell, a quadruple-level cell (QLC) format may write four bits per memory cell, and so on. A format used to store fewer bits per memory cell may be accessed faster than a format used to store more bits per memory cell.

The storage device may write data to the memory device using a two-stage programming approach, including, for example, Foggy Fine, encoded Foggy Fine, or MLC Fine. In the first programming stage (e.g., the foggy or MLC stage), data may be initially written on a memory cell in a less precise manner, using a smaller voltage or a different encoding scheme. In the second programming stage (i.e., the fine stage), the value stored in the memory cell may be reprogrammed and fine-tuned with final, more precise data.

When sudden power loss occurs on the storage device, the storage device may use backup power provided by capacitor(s) on the storage device to wrap up ongoing operations. For example, in some cases, when sudden power loss occurs while the storage device is performing fine operations, backup power provided by capacitors may be used to complete the fine operations. To ensure that all ongoing fine operations are completed during sudden power loss, the capacitor(s) may need to provide sufficient backup power to complete the ongoing fine operations. This may require adding additional capacitors to the storage device which may be costly in terms of, for example, the board space needed to house the additional capacitors and the cost of the additional capacitors.

When the backup power is insufficient to complete all of the on-going fine operations, the storage device may enter an SLC Cache RAM (SCRAM) state, wherein the storage device may abort the ongoing fine programming and store data associated with aborted fine programing in a SLC cache using the backup capacitor energy. Aborting the fine programming may corrupt some word lines in the memory device. As such, when the storage device is rebooted, the storage device may have to complete the aborted fine programming by copying the data from the SLC cache to, for example, QLC memory, and handle the corrupted data word lines.

While the storage device is cleaning up data (i.e., handling the corrupted data word lines and completing the aborted fine programming), if another sudden power loss occurs, the storage device may have to abort the ongoing fine programming, and more word lines may become corrupted by the aborted fine programming. The cleanup operation for completing the aborted fine programming and handling the corrupted data word lines after the storage device is rebooted may thus be problematic when repeated sudden power losses occur during cleanup operations.

Consider an example where the storage device is rebooted after a first sudden power loss, and the storage device is copying the aborted data stored in the SLC cache to a QLC memory device. If a subsequent/second sudden power loss occurs while the data is being copied (i.e., during the cleanup operation for the first sudden power loss), the storage device may abort copying the cached SLC data, which may corrupt additional word lines in the memory device. As such, the amount of aborted data and correspondingly the amount of SLC cache data that may need to be preserved may increase. Additionally, the aborting of the copying of cached SLC data and the handling of corrupted data word lines which may lead to corrupting more word lines may eventually result in block management issues on the memory device.

### SUMMARY OF THE INVENTION

In some implementations, a storage device may complete aborted operations during initialization. The storage device includes a memory device including a single-level cell (SLC) cache and a multi-cell storage section. A controller may store data to the memory device in two-stage programming operations when the storage device is in a first state. The controller may determine that sudden power loss occurred on the storage device, enter a second state, abort ongoing second programming operations, and store data associated with aborted ongoing second programming operations to the SLC cache. The controller may also determine that the storage device is rebooted after the sudden power loss and cause the storage device to enter a third state. In the third state, the controller may process the aborted second programming operations, determine that a subsequent sudden power loss occurred while processing a first set of aborted second programming operations, complete the first set of aborted second programming operations before the storage device is rebooted, and transition to the first state when all aborted second programming operations are reprogrammed to the multi-cell storage section.

In some implementations, a storage device may complete aborted operations during initialization. The storage device includes a memory device including an SLC cache and a multi-cell storage section. A controller on the storage device may store data to the memory device in a two-stage programming when the storage device is in a first state. The controller may determine that a first sudden power loss occurred on the storage device, enter a second state, abort ongoing second programming operations, and store aborted ongoing second programming operations to the SLC cache. The controller may determine that the storage device is rebooted after the first sudden power loss and cause the storage device to enter a third state. In the third state, the controller may process a first set of the aborted second programming operations based on backup energy allowance of the storage device, determine that a second sudden power loss occurred on the storage device, complete the first set of the aborted second programming operations prior to rebooting the storage device, and determine that the storage device is rebooted after the second sudden power loss. The controller may process a second set of the aborted second programming operations based on backup energy allowance, complete the second set of the aborted second programming operations prior to rebooting the storage device based on a subsequent power loss, and transition to the first state when all aborted second programming operations are reprogrammed to the multi-cell storage section.

In some implementations, a method is provided for completing aborted operations on a storage device. The method includes storing data to a memory device in a two-stage programming operation when the storage device is in a first state. The method also includes determining that sudden power loss occurred on the storage device, entering a second state, aborting ongoing second programming operations, and storing data associated with aborted ongoing second programming operations to an SLC cache. The method further includes determining that the storage device is rebooted after the sudden power loss and causing the storage device to enter a third state, processing the aborted second programming operations, determining that a subsequent sudden power loss occurred while processing a first set of aborted second programming operations, completing the first set of aborted second programming operations before the storage device is rebooted, and transitioning to the first state when all aborted second programming operations are reprogrammed to the multi-cell storage section.

### BRIEF DESCRIPTION OF THE DRAWINGS

FIG. 1 is a schematic block diagram of an example system in accordance with some implementations.

FIG. 2 is a block diagram of an example memory device showing the scale of corruption due to the abortion of fine programming in accordance with some implementations.

FIG. 3 is an example flow diagram for transitioning a storage device from a full performance mode to a power loss protection (PLP) recovery state in accordance with some implementations.

FIG. 4 is an example flow diagram processing aborted operations in the PLP recovery state in accordance with some implementations.

FIG. 5 is a diagram of an example environment in which systems and/or methods described herein are implemented.

FIG. 6 is a diagram of example components of one or more devices of FIG. 1.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of implementations of the present disclosure.

The apparatus and method components have been represented where appropriate by conventional symbols in the drawings, showing those specific details that are pertinent to understanding the implementations of the present disclosure so as not to obscure the disclosure with details that will be readily apparent to those of ordinary skill in the art.

### DETAILED DESCRIPTION OF THE INVENTION

The following detailed description of example implementations refers to the accompanying drawings. The same reference numbers in different drawings may identify the same or similar elements.

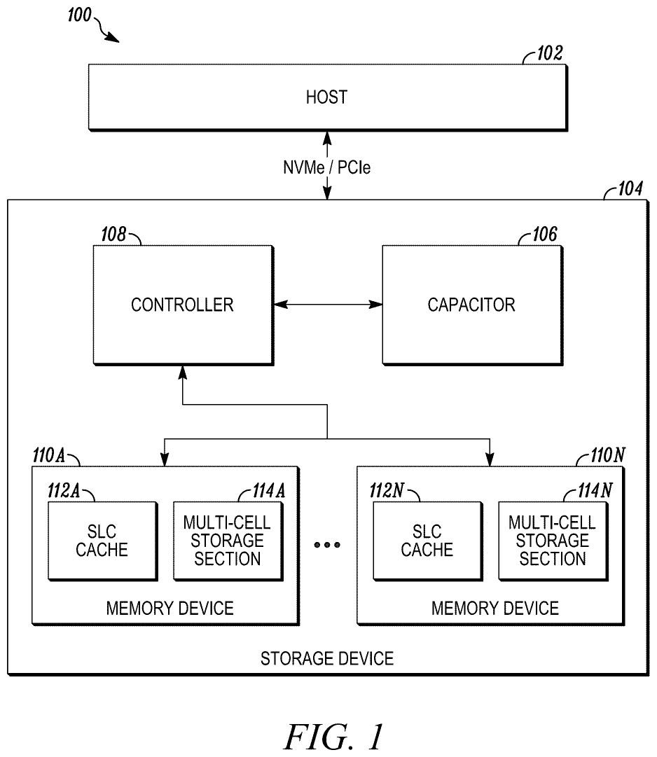

FIG. 1 is a schematic block diagram of an example system in accordance with some implementations. System 100 may include a host 102 and a storage device 104 that may be in the same physical location as components on a single computing device or on different computing devices that are communicatively coupled. Host 102 may provide operational power for storage device 104 and notify storage device 104 about the maximum/peak host power to be used by storage device 104. Storage device 104 may communicate with host 102 via a Non-Volatile Memory Express (NVMe) protocol over a peripheral component interconnect express (PCIe) bus, and the like. Host 102 may include additional components (not shown in this figure for the sake of simplicity).

Storage device 104 may be, for example, a solid-state drive (SSD) that may include a capacitor 106, a controller 108 and one or more storage components such as non-volatile memory devices 110a-110n (referred to herein as the memory device(s) 110). Capacitor 106 may provide backup power for storage device 104 to complete ongoing operations (for example, ongoing write/program operations) when there is sudden power loss.

Controllers 108 may interface with host 102 and process foreground operations including instructions transmitted from host 102. For example, controllers 108 may read data from and/or write to memory devices 110 based on instructions received from host 102. Controllers 108 may also execute background operations to manage resources on memory device 110. For example, controllers 108 may monitor memory devices 110 and may execute garbage collection and other relocation functions per internal relocation algorithms to refresh, recycle, and/or relocate the data on memory devices 110.

Memory devices 110 may be flash based. For example, memory devices 110 may be a NAND or NOR flash memory that may be used for storing host and control data over the operational life of memory devices 110. Memory devices 110 may include one or more dies (for example, die 0-die N) connected to a memory bus including data lines and chip enable lines. Data may be stored in the blocks on a die in various formats, with the formats being defined by the number of bits that may be stored per memory cell. For example, a single-level cell (SLC) format may write one bit per memory cell, a multi-level cell (MLC) format may write two bits per memory cell, a triple-level cell (TLC) format may write three bits per memory cell, a quadruple-level cell (QLC) format may write four bits per memory cell, and so on. A format used to store fewer bits per memory cell may be accessed faster and more expensive than a format used to store more bits per memory cell.

Memory device 110 may include an SLC cache 112a-112n (referred to herein as the SLC cache(s) 112) and a multi-cell storage section 114a-114n (referred to herein as the multi-cell storage section(s) 112). Multi-cell storage section 114 may include memory cells that may store multiple bits in, for example, MLC, TLC, or QLC formats. SLC cache 112 may temporarily store data that may be subsequently reprogrammed in multi-cell storage section 114. During normal/sustained write operations on storage device 104, controller 108 may write data to blocks in multi-cell storage section 114. Memory device 110 may be included in storage device 104 or may be otherwise communicatively coupled to storage device 104.

Storage device 104 may operate in full performance mode (also referred to herein as a first state), wherein controller 108 may send data for storage in multi-cell storage section 114. When memory device 110 stores multiple bits in its memory cells, memory device 110 may be referred to herein as multi-cell memory device 110. Storage device 104 may write data to multi-cell memory device 110 using two-stage programming, including, for example, Foggy Fine programming, encoded Foggy Fine programming, MLC+Fine programming, etc. The two-stage programming may include a first programming operation (for example, foggy or MLC programming) and a second programming operation (for example, fine programming operation).

When the foggy operation is performed on, for example a QLC memory device 110, four pages may be transferred to QLC memory device 110 and programmed to a first word line (N) in a foggy state. These first four pages may be unreadable until a fine programing operation is performed. Four new pages may be transferred to a second word line (N+1) of the same QLC memory device die and programmed in the foggy state. The four new/second pages may also be unreadable until a fine programing operation is performed. Storage device 104 may perform fine programming on the first four pages in word line N and transfer the first four pages to QLC memory device 110 to have the data fully written and readable in the QLC memory device 110. Storage device 104 may alternate between the foggy and fine programs. Until the fine program completes, the data in the foggy state may be at risk in case of sudden power loss.

When the MLC+Fine programming is performed on, for example, QLC memory device 110, storage device 104 may transfer two pages to a first word line (N) and word line N may be programmed in an MLC state. The two pages in word line N may be readable. Two other pages may be transferred to a second word line (N+1) and word line N+1 may be programmed in an MLC state The two pages in word line N+1 may also be readable. The two pages in word line N plus two new pages sent to word line N may be programmed in a fine operation. Storage device 104 may continue to alternate between the MLC and fine programming as it goes through subsequent word lines. Until the fine program completes, the data in the MLC state may be at risk in case of sudden power loss. It should be noted that two-stage programming may be carried out on any multi-cell memory device 110 and that discussion herein of the two-stage programming being carried out on QLC memory device 110 is only provided as an example.

When sudden power loss occurs while storage device 104 is performing fine operations, storage device 104 may enter a SCRAM state (also referred to herein as a second state). In the SCRAM state, controller 108, using backup power provided by capacitor 106, may abort the fine operations that are in progress and write the data to SLC cache 112. When storage device 104 is rebooted, during an initialization period, controller 108 may determine that storage device 104 had previously encountered sudden power loss and cause storage device 104 to enter a power loss protection (PLP) recovery state (also referred to herein as a third state).

When storage device 104 is in the PLP recovery state, controller 108 may manage the resources on storage device 104 to enable the aborted fine programs to complete. In the PLP recovery state, storage device 104 may run on reduced processor clocks to reduce energy and limit power utilization below what storage device 104 would normally require in the full performance mode/first state. Controller 108 may determine the holdup/backup energy allowance provided by capacitor 106. Storage device 104 may allow programs, including fine programs to complete within the backup energy allowance. Controller 108 may also limit the number of new host writes that may be processed to divert the backup energy that would normally be applied to caching uncommitted host writes to SLC cache 112 to completing the aborted fine programming. In some cases, storage device 104 may limit the number of new host writes to zero. Storage device 104 may also limit the number of fine program/write operations that may be processed as a given time. For example, storage device 104 may limit the number of fine programs being processed at a given time to a number that may be completed using the backup energy allowance.

Storage device 104 may remain in the PLP recovery state until the data associated with all of the aborted fine programs are programed to QLC memory device 110. As such, storage device 104 may remain in the PLP recovery state until there is no longer any data stored in SLC cache 112 that needs to be flushed to QLC memory device 110. Controller 108 may also perform sufficient garbage collection to run storage device 104 at full performance (i.e., in the first state) when storage device 104 exists the PLP recovery state (i.e., the third state). When there is no more data stored in SLC cache 112 that needs to be flushed to QLC memory device 110 and controller 108 has performed sufficient garbage collection to run the storage device 104 at full performance, storage device 104 may transition back to the full performance mode.

Consider an example where storage device 104 is in full performance mode and is writing data to, for example, QLC memory device 110 using two-stage programming when storage device 104 experiences a first sudden power loss. Storage device 104 may enter the SCRAM state, abort on-going fine operations, and use the backup power provided by capacitor 106 to copy data associated with the ongoing fine operations to SLC cache 112. When storage device 104 aborts the on-going fine operations, word lines including, for example, word lines that are adjacent to the word lines associated with the aborted on-going fine operations may be corrupted.

When storage device 104 is rebooted after the first sudden power loss, storage device 104 may enter the PLP recovery state and controller 108 may determine the backup energy allowance provided by capacitor 106. Storage device 104 may limit the drive performance in the PLP recovery state to ensure that storage device 104 has sufficient power to complete the aborted fine operations and handle the corrupted data word lines. Controller 108 may handle the corrupted data word lines by programming data in the corrupted word lines to other word lines in multi-cell storage section 114. If, for example, controller 108 determines that 128 program operations are needed to complete the aborted fine operations and handle the corrupted data word lines and storage device determines that the backup energy allowance can support 64 operations, storage device 104 may process a first set of operations that may be supported by the backup energy allowance. For example, storage device 104 may process less than 64 fine operations in the first set of operations. When the first set of fine operations is complete, storage device 104 may process other set(s) of operations until the data stored in SLC cache 112 is cleared and the corrupted word lines are corrected.

If while storage device 104 is processing the first set of operations, storage device experiences a second sudden power loss, storage device 104 may use the backup power provided to capacitor 106 to complete processing the first set of operations. Storage device 104 may not abort the first set of operations because of the second sudden power loss. When the first set of operations is completed, storage device 104 may be rebooted. When storage device 104 is rebooted, during the initialization period, controller 108 may determine that storage device 104 had previously encountered sudden power loss and cause storage device 104 to remain in the PLP recovery state. Controller 108 may determine the backup energy allowance provided by capacitor 106 and storage device 104 may limit the drive performance in the PLP recovery state to ensure that storage device 104 has sufficient power to complete the remaining aborted fine operations and handle corrupted data word lines.

Storage device 104 may process the other set(s) of operations that were not processed after the first sudden power loss. For example, if storage device 104 completed a first set of 64 fine program operations after the first sudden power loss and did not complete the other 64 fine program operations prior to the second sudden power loss, based on the backup energy allowance, storage device 104 may complete processing the one or more sets of operations in the PLP recover state. For each set of operations being processed in the PLP recover state, storage device 104 may ensure that the set of operations is completed even when there is a sudden power loss while the set of operations is being processed. At some point, even with repeated power loss, storage device may repair the failures and complete processing the fine programs associated with the first sudden power loss.

After storage device 104 repairs the failures associated with the first sudden power loss and controller 108 performs sufficient garbage collection to run storage device 104 at full performance, storage device 104 may return to full performance mode. If storage device 104 experiences another power loss, storage device 104 may return to processing the power loss as though it is a first sudden power loss. Storage device 104 may therefore prevent error propagation and/or corruption associated with aborting fine programming during repeated sudden power loss.

Storage device 104 may optimize holdup capacitance to support what is needed for full performance of storage device 104. With the PLP recovery state, there may be no need for additional capacitance to enable all the aborted fine programs to complete. Instead, the current capacitance may be budgeted to cache the needed data to SLC cache 112 during power loss and abort programs that can be cached. In the PLP recovery state, storage device 104 may operate with sufficient holdup power to complete in-progress writes, simplifying handling of pathological back-to-back sudden power loss events that may otherwise corrupt data.

Controller 108 handling of aborted writes may be simplified, as controller 108 may need to handle only a set of aborted writes associated with a single sudden power loss. While storage device 104 is handling the current aborted writes, storage device 104 may be executed in a state where no further corruption of host data may occur due to no additional aborted writes. The recovery time for back-to-back PLPs may be bounded and the recovery flow may be re-entrant, with no need to start over each time

Storage device 104 may perform these processes based on one or more processors, for example, controller 108 and the components therein executing software instructions stored by a non-transitory computer-readable medium, such as storage component including, for example, memory device 110. As used herein, the term “computer-readable medium” refers to a non-transitory memory device. Software instructions may be read into the storage component from another computer-readable medium or from another device. When executed, software instructions stored in the storage component may cause controller 108 to perform one or more processes described herein. Additionally, or alternatively, hardware circuitry may be used in place of or in combination with software instructions to perform one or more processes described herein. Thus, implementations described herein are not limited to any specific combination of hardware circuitry and software. System 100 may include additional components (not shown in this figure for the sake of simplicity). FIG. 1 is provided as an example. Other examples may differ from what is described in FIG. 1.

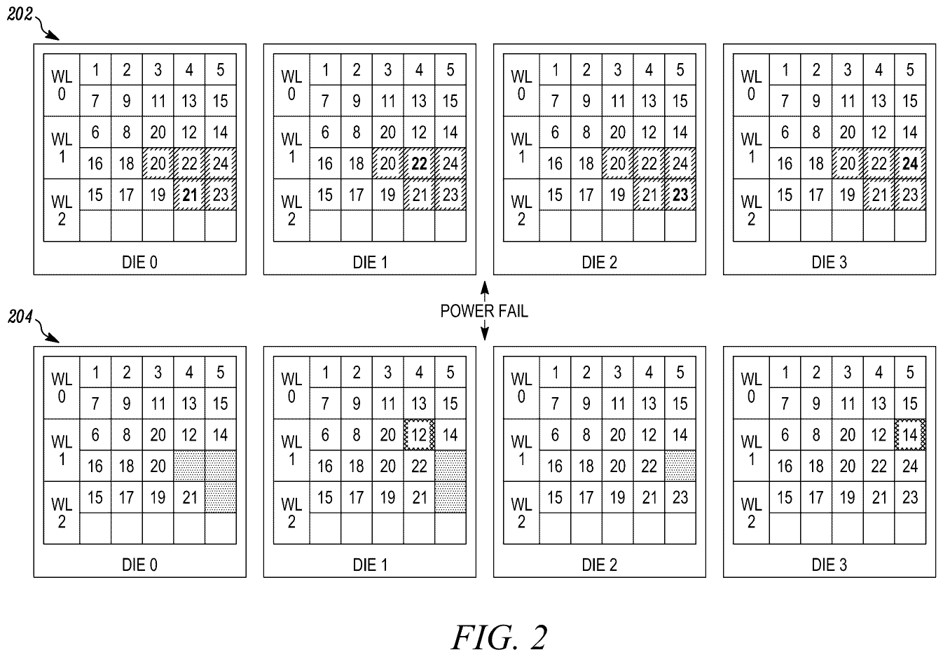

FIG. 2 is a block diagram of an example memory device showing the scale of corruption due to the abortion of fine programming in accordance with some implementations. 202 shows memory device 110 including dies 0-3 and word lines (WL) 0-2. The sections of each die with slanted lines are scheduled for fine programming. The bold numbers in sections of each die with slanted lines show sections on which on-going fine programming may be in process. As such, on-going fine programming may be in process on section 21 of die 0, section 22 of die 1, section 23 of die 2, and section 24 of die 3. If there is a sudden power failure while storage device 104 is performing the fine programming, the storage device 104 may abort the fine programming and store the data associated with the aborted fine programming in SLC cache 112. 204 shows the state of word lines in memory device 110 after the power failure. In aborting the fine programming of block 21 of die 0, the programming scheduled on the blocks shown as shaded sections (i.e., blocks 22, 23 and 24 before the power failure) were not performed. In aborting the fine programming of block 22 of die 1, the programming scheduled on the blocks shown as shaded sections (i.e., blocks 23 and 24 before the power failure) were not performed and block 12 (shown with a diamond pattern) may be corrupted. In aborting the fine programming of block 23 of die 2, the programming scheduled on the block shown as shaded sections (i.e., block 24 before the power failure) was not performed. In aborting the fine programming of block 24 of die 3, block 14 (shown with a diamond pattern) may be corrupted. FIG. 2 is provided as an example. Other examples may differ from what is described in FIG. 2.

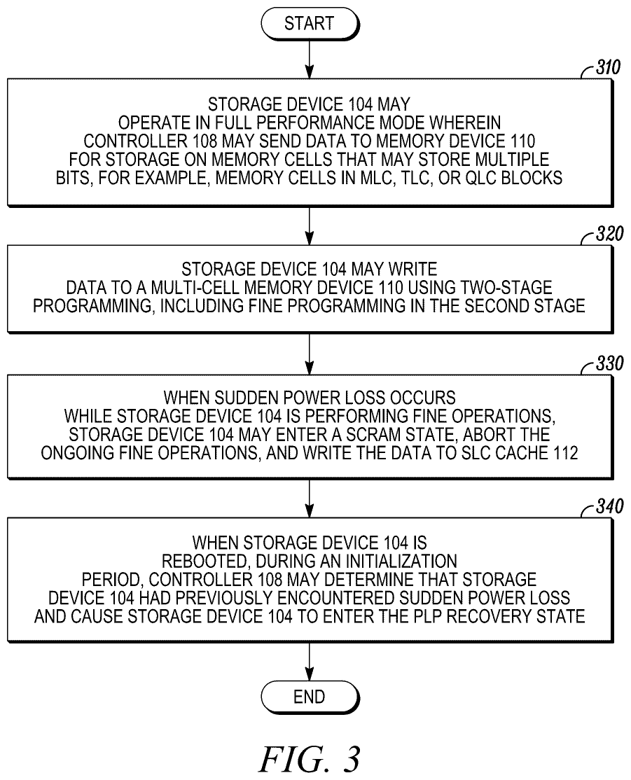

FIG. 3 is an example flow diagram for transitioning a storage device from a full performance mode to a power loss protection (PLP) recovery state in accordance with some implementations. At 310, storage device 104 may operate in full performance mode wherein controller 108 may send data to memory device 110 for storage on memory cells that may store multiple bits, for example, memory cells in MLC, TLC, or QLC blocks. At 320, storage device 104 may write data to a multi-cell memory device 110 using two-stage programming, including fine programming in the second stage. At 330, when sudden power loss occurs while storage device 104 is performing fine operations, storage device 104 may enter a SCRAM state, abort the ongoing fine operations, and write the data to SLC cache 112. At 340. when storage device 104 is rebooted, during an initialization period, controller 108 may determine that storage device 104 had previously encountered sudden power loss and cause storage device 104 to enter the PLP recovery state. FIG. 3 is provided as an example. Other examples may differ from what is described in FIG. 3.

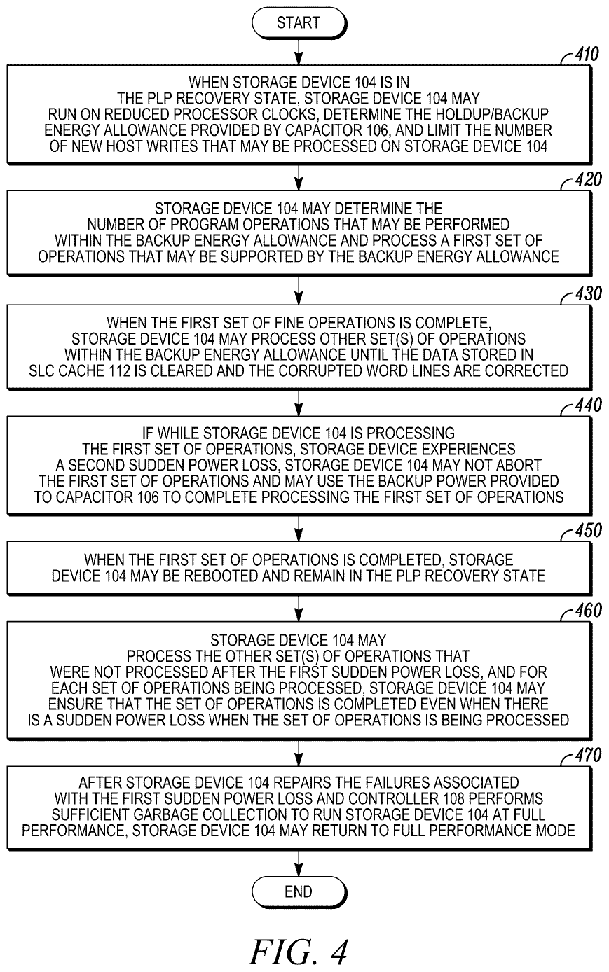

FIG. 4 is an example flow diagram processing aborted operations in the PLP recovery state in accordance with some implementations. At 410, when storage device 104 is in the PLP recovery state, storage device 104 may run on reduced processor clocks, determine the holdup/backup energy allowance provided by capacitor 106, and limit the number of new host writes that may be processed on storage device 104. At 420, storage device 104 may determine the number of program operations that may be performed within the backup energy allowance and process a first set of operations that may be supported by the backup energy allowance. At 430, when the first set of fine operations is complete, storage device 104 may process other set(s) of operations within the backup energy allowance until the data stored in SLC cache 112 is cleared and the corrupted word lines are corrected. At 440, if while storage device 104 is processing the first set of operations, storage device experiences a second sudden power loss, storage device 104 may not abort the first set of operations and may use the backup power provided to capacitor 106 to complete processing the first set of operations. At 450, when the first set of operations is completed, storage device 104 may be rebooted and remain in the PLP recovery state. At 460, storage device 104 may process the other set(s) of operations that were not processed after the first sudden power loss, and for each set of operations being processed, storage device 104 may ensure that the set of operations is completed even when there is a sudden power loss when the set of operations is being processed. At 470, after storage device 104 repairs the failures associated with the first sudden power loss and controller 108 performs sufficient garbage collection to run storage device 104 at full performance, storage device 104 may return to full performance mode. As indicated above FIG. 4 is provided as an example. Other examples may differ from what is described in FIG. 4.

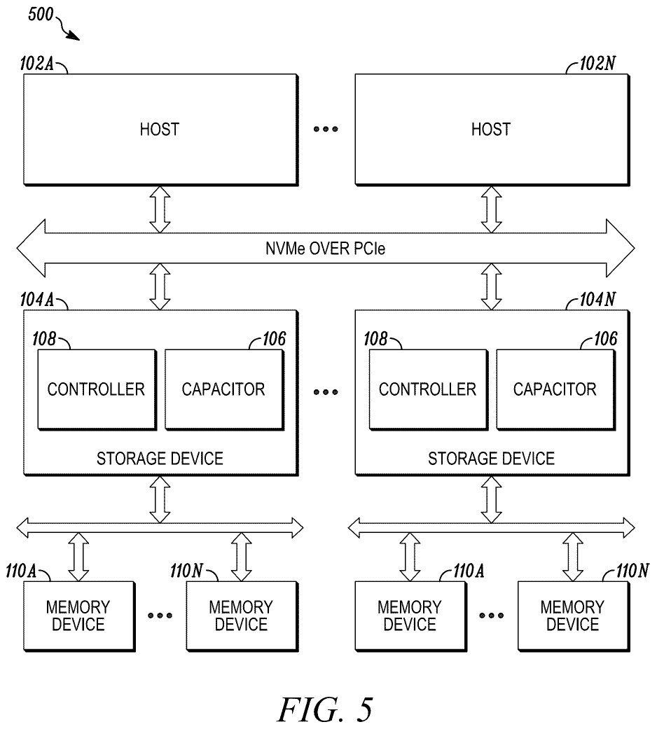

FIG. 5 is a diagram of an example environment in which systems and/or methods described herein are implemented. As shown in FIG. 5, Environment 500 may include hosts 102-102n (referred to herein as host(s) 102), and one or more storage devices 104a-104n (referred to herein as storage device(s) 104). Controller 108 may use power from a capacitor to complete aborted fine programming when storage device 104 enters the PLP recovery state. Hosts 102 and storage devices 104 may communicate via Non-Volatile Memory Express (NVMe) over peripheral component interconnect express (PCI Express or PCIe), SD, or the like.

Devices of Environment 500 may interconnect via wired connections, wireless connections, or a combination of wired and wireless connections. For example, the network in FIG. 5 may include NVMe over Fabric(NVMe-oF) Internet Small Computer Systems Interface (iSCSI), Fibre Channel (FC), Fibre Channel Over Ethernet (FCoE) connectivity and any another type of next-generation network and storage protocols, a local area network (LAN), a wide area network (WAN), a metropolitan area network (MAN), a private network, an ad hoc network, an intranet, the Internet, a fiber optic-based network, a cloud computing network, or the like, and/or a combination of these or other types of networks.

The number and arrangement of devices and networks shown in FIG. 5 are provided as an example. In practice, there may be additional devices and/or networks, fewer devices and/or networks, different devices and/or networks, or differently arranged devices and/or networks than those shown in FIG. 5. Furthermore, two or more devices shown in FIG. 5 may be implemented within a single device, or a single device shown in FIG. 5 may be implemented as multiple, distributed devices. Additionally, or alternatively, a set of devices (e.g., one or more devices) of Environment 500 may perform one or more functions described as being performed by another set of devices of Environment 500.

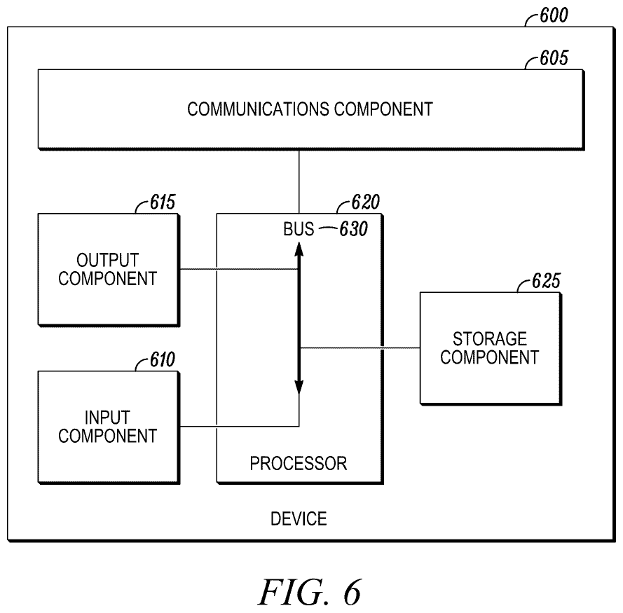

FIG. 6 is a diagram of example components of one or more devices of FIG. 1. In some implementations, host 102 may include one or more devices 600 and/or one or more components of device 600. Device 600 may include, for example, a communications component 605, an input component 610, an output component 615, a processor 620, a storage component 625, and a bus 630. Bus 630 may include components that enable communication among multiple components of device 600, wherein components of device 600 may be coupled to be in communication with other components of device 600 via bus 630.

Input component 610 may include components that permit device 600 to receive information via user input (e.g., keypad, a keyboard, a mouse, a pointing device, and a network/data connection port, or the like), and/or components that permit device 600 to determine the location or other sensor information (e.g., an accelerometer, a gyroscope, an actuator, another type of positional or environmental sensor). Output component 615 may include components that provide output information from device 600 (e.g., a speaker, display screen, and network/data connection port, or the like). Input component 610 and output component 615 may also be coupled to be in communication with processor 620.

Processor 620 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 620 may include one or more processors capable of being programmed to perform a function. Processor 620 may be implemented in hardware, firmware, and/or a combination of hardware and software.

Storage component 625 may include one or more memory devices, such as random-access memory, read-only memory (ROM), and/or another type of dynamic or static storage device (e.g., a flash memory, a magnetic memory, and/or optical memory) that stores information and/or instructions for use by processor 620. A memory device may include memory space within a single physical storage device or memory space spread across multiple physical storage devices. Storage component 625 may also store information and/or software related to the operation and use of device 600. For example, storage component 625 may include a hard disk (e.g., a magnetic disk, an optical disk, and/or a magneto-optic disk), a solid-state drive (SSD), a compact disc (CD), a digital versatile disc (DVD), a floppy disk, a cartridge, a magnetic tape, CXL device and/or another type of non-transitory computer-readable medium, along with a corresponding drive.

Communications component 605 may include a transceiver-like component that enables device 600 to communicate with other devices, such as via a wired connection, a wireless connection, or a combination of wired and wireless connections. The communications component 605 may permit device 600 to receive information from another device and/or provide information to another device. For example, communications component 605 may include an Ethernet interface, an optical interface, a coaxial interface, an infrared interface, a radio frequency (RF) interface, a universal serial bus (USB) interface, a Wi-Fi interface, and/or a cellular network interface that may be configurable to communicate with network components, and other user equipment within its communication range. Communications component 605 may also include one or more broadband and/or narrowband transceivers and/or other similar types of wireless transceiver configurable to communicate via a wireless network for infrastructure communications. Communications component 605 may also include one or more local area network or personal area network transceivers, such as a Wi-Fi transceiver or a Bluetooth transceiver.

Device 600 may perform one or more processes described herein. For example, device 600 may perform these processes based on processor 620 executing software instructions stored by a non-transitory computer-readable medium, such as storage component 625. As used herein, the term “computer-readable medium” refers to a non-transitory memory device. Software instructions may be read into storage component 625 from another computer-readable medium or from another device via communications component 605. When executed, software instructions stored in storage component 625 may cause processor 620 to perform one or more processes described herein. Additionally, or alternatively, hardware circuitry may be used in place of or in combination with software instructions to perform one or more processes described herein. Thus, implementations described herein are not limited to any specific combination of hardware circuitry and software.

The number and arrangement of components shown in FIG. 6 are provided as an example. In practice, device 600 may include additional components, fewer components, different components, or differently arranged components than those shown in FIG. 6. Additionally, or alternatively, a set of components (e.g., one or more components) of device 600 may perform one or more functions described as being performed by another set of components of device 600.

The foregoing disclosure provides illustrative and descriptive implementations but is not intended to be exhaustive or to limit the implementations to the precise form disclosed herein. One of ordinary skill in the art will appreciate that various modifications and changes can be made without departing from the scope of the present disclosure as set forth in the claims below. Accordingly, the specification and figures are to be regarded in an illustrative rather than a restrictive sense, and all such modifications are intended to be included within the scope of present teachings.

As used herein, the term “component” is intended to be broadly construed as hardware, firmware, and/or a combination of hardware and software. It will be apparent that systems and/or methods described herein may be implemented in different forms of hardware, firmware, and/or a combination of hardware and software.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items and may be used interchangeably with “one or more.” Furthermore, as used herein, the term “set” is intended to include one or more items (e.g., related items, unrelated items, a combination of related items, unrelated items, and/or the like), and may be used interchangeably with “one or more.” The term “only one” or similar language is used where only one item is intended. Further, the phrase “based on” is intended to mean “based, at least in part, on” unless explicitly stated otherwise.

Moreover, in this document, relational terms such as first and second, top and bottom, and the like, may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, or “contains . . . a” does not, without more constraints, preclude the existence of additional identical elements in the process, method, article, or apparatus that comprises, has, includes, contains the element. The terms “substantially”, “essentially”, “approximately”, “about” or any other version thereof, are defined as being close to as understood by one of ordinary skill in the art, and in one non-limiting implementation, the term is defined to be within 10%, in another implementation within 5%, in another implementation within 1% and in another implementation within 0.5%. The term “coupled” as used herein is defined as connected, although not necessarily directly and not necessarily mechanically. A device or structure that is “configured” in a certain way is configured in at least that way but may also be configured in ways that are not listed.

We claim:

1. A storage device to complete aborted operations during initialization, the storage device comprises:
a memory device including a single-level cell (SLC) cache and a multi-cell storage section; and
a controller to
store data to the memory device in two-stage programming operations when the storage device is in a first state,
determine that sudden power loss occurred on the storage device, enter a second state, abort ongoing second programming operations, and store data associated with aborted ongoing second programming operations to the SLC cache,
determine that the storage device is rebooted after the sudden power loss and cause the storage device to enter a third state, process a first set of aborted second programming operations, determine that a subsequent sudden power loss occurred while processing the first set of aborted second programming operations, complete the first set of aborted second programming operations before the storage device is rebooted, and transition to the first state when the aborted second programming operations are reprogrammed to the multi-cell storage section.

2. The storage device of claim 1, wherein the two-stage programming operations includes a first programming operation wherein data is written to a memory cell using one of a smaller voltage and a different encoding scheme and a second programming operation wherein data is reprogrammed on the memory cell.

3. The storage device of claim 1, wherein the controller uses backup power to store the data associated with the aborted ongoing second programming operations to the SLC cache.

4. The storage device of claim 1, wherein when the storage device is in the third state, the storage device is run on reduced processor clocks to reduce energy and limit power utilization below energy and power used on the storage device in the first state and the controller limits a number of new host write operations performed on the storage device.

5. The storage device of claim 1, wherein when the storage device is in the third state, the controller determines backup energy allowance on the storage device and allows the aborted second programming operations to complete within the backup energy allowance, wherein the controller limits a number of aborted second programming operations based on the backup energy allowance.

6. The storage device of claim 1, wherein when the storage device is in the third state, the controller performs garbage collection to run the storage device in the first state when the storage device exists from the third state.

7. The storage device of claim 1, wherein the storage device transitions from the third state to the first state when the controller performs garbage collection to run the storage device in the first state and when the aborted second programming operations are reprogrammed to the multi-cell storage section.

8. The storage device of claim 1, wherein when the controller processes the aborted second programming operations, the controller reprograms data copied to the SLC cache and handles corrupted word lines that were corrupted when the ongoing second programming operations were aborted in the second state.

9. The storage device of claim 1, wherein when the storage device is in the third state, the controller handles a set of aborted writes associated with a single sudden power loss without incurring further corruption of host data.

10. A storage device to complete aborted operations during initialization, the storage device comprises:
a memory device including a single-level cell (SLC) cache and a multi-cell storage section; and
a controller to
store data to the memory device in a two-stage programming when the storage device is in a first state,
determine that a first sudden power loss occurred on the storage device, enter a second state, abort ongoing second programming operations, and store aborted ongoing second programming operations to the SLC cache,
determine that the storage device is rebooted after the first sudden power loss and cause the storage device to enter a third state, process a first set of the aborted second programming operations based on backup energy allowance of the storage device, determine that a second sudden power loss occurred on the storage device, complete the first set of the aborted second programming operations, determine that the storage device is rebooted after the second sudden power loss, process a second set of the aborted second programming operations based on backup energy allowance, complete the second set of the aborted second programming operations prior to rebooting the storage device based on a subsequent power loss, and transition to the first state when the aborted second programming operations are reprogrammed to the multi-cell storage section.

11. A method for completing aborted operations on a storage device, the storage device comprises a controller to execute the method comprising:
storing data to a memory device in a two-stage programming operation when the storage device is in a first state;
determining that sudden power loss occurred on the storage device, entering a second state, aborting ongoing second programming operations, and storing data associated with aborted ongoing second programming operations to an SLC cache; and
determining that the storage device is rebooted after the sudden power loss and causing the storage device to enter a third state, processing the aborted second programming operations, determining that a subsequent sudden power loss occurred while processing a first set of aborted second programming operations, completing the first set of aborted second programming operations before the storage device is rebooted, and transitioning to the first state when the aborted second programming operations are reprogrammed to a multi-cell storage section on the memory device.

12. The method of claim 11, further comprising writing data to a memory cell using one of a smaller voltage and a different encoding scheme in a first programming operation and reprogramming data on the memory cell in a second programming operation.

13. The method of claim 11, further comprising using backup power to store the data associated with the aborted ongoing second programming operations to the SLC cache.

14. The method of claim 11, further comprising, when the storage device is in the third state, running the storage device on reduced processor clocks to reduce energy and limit power utilization below energy and power used on the storage device in the first state and limiting a number of new host write operations performed on the storage device.

15. The method of claim 11, further comprising, when the storage device is in the third state, determining backup energy allowance on the storage device and allowing the aborted second programming operations to complete within the backup energy allowance.

16. The method of claim 11, further comprising, when the storage device is in the third state, processing the aborted second programming operations in sets based on backup energy allowance on the storage device.

17. The method of claim 11, further comprising, when the storage device is in the third state, performing garbage collection to run the storage device in the first state when the storage device exists from the third state.

18. The method of claim 11, further comprising transitioning the storage device from the third state to the first state when the controller performs garbage collection to run the storage device in the first state and when the aborted second programming operations are reprogrammed to the multi-cell storage section.

19. The method of claim 11, further comprising reprograming data copied to the SLC cache and handling corrupted word lines that were corrupted when the ongoing second programming operations were aborted in the second state when processing the aborted second programming operations.

20. The method of claim 11, further comprising, when the storage device is in the third state, handling a set of aborted writes associated with a single sudden power loss without incurring further corruption of host data.
